(19) United States
(12) Patent Application Publication
(10) Pub. No.: US 2003/0226024 A1
(43) Pub. Date: Dec. 4, 2003

(54) Secure internet documents

(75) Inventor: Anthony Sweets, Westminster, CO (US)

Correspondence Address: QWEST COMMUNICATIONS INTERNATIONAL INC, LAW DEPT INTELLECTUAL PROPERTY GROUP, 1801 CALIFORNIA STREET, SUITE 3800, DENVER, CO, 80202, US

(73) Assignee: Qwest Communications International Inc., Denver, CO

(21) Appl. No.: 10/161,919

(22) Filed: Jun. 4, 2002

(51) Int. Cl. H04L 9/00

(52) U.S. Cl. 713/193

(57) ABSTRACT

Unauthorized alteration of documents is reduced by encrypting secured documents held by an Internet server. A crypt engine encrypts each document when stored in a secured storage and decrypts the document when retrieved from the secure storage for delivery by the server to each requesting client.

### BACKGROUND OF THE INVENTION

1. Field of the Invention

This invention relates to storing and sending documents accessed via the Internet.

2. Background Art

The Internet provides an ever increasing means of disseminating information. Typically, information is sent in the form of documents provided by a server to a requesting client over the Internet. For example, web pages written in HTML are accessed by clients using a web browser. In addition to on-line access, documents may be downloaded for future use by a client. Such documents come in a wide variety of formats including PDF, MPEG, JPEG, MP3, ASCII text, and the like.

One problem with serving documents over the Internet is vandalizing or “defacing” documents kept at the server. Typically, a server will be protected by a firewall or similar software to prevent unauthorized access. However, hackers routinely break through such protection and access documents stored at the server. These hackers may then modify the documents. Often, an organization supplying the documents does not know that a document has been modified until notified by a client accessing the document.

What is needed is to protect documents from unauthorized alterations. Such protection should not interfere with the allowed access of the documents through the server.

### SUMMARY OF THE INVENTION

The present invention greatly reduces the chance of unauthorized alteration of server documents by encrypting secured documents held by the server.

A system for serving documents over the Internet to a plurality of clients is provided. A server sends documents over the Internet in response to requests from clients. A secure storage holds encrypted documents. A crypt engine encrypts each document when stored in the secured storage and decrypts the document when retrieved from the secure storage for delivery to requesting clients.

In an embodiment of the present invention, the server never permanently stores a document held in secure storage as an unencrypted document outside of the secure storage.

In another embodiment of the present invention, a system administrator uploads encrypted documents to the server for access by the clients. The unencrypted documents are then encrypted by the crypt engine and stored in the secure storage.

In still another embodiment of the present invention, an unsecure storage holds unencrypted documents. The server receives a client request for access to a document. The server determines whether or not the requested document is in secure storage or unsecure storage. If this document is in unsecure storage, the document is retrieved and sent to the requesting client. If the document is in secure storage, the document is decrypted through the crypt engine and sent to the requesting client.

A method for serving Internet-based documents to at least one requesting client is also provided. A document is encrypted and stored. A request is received from a client to access the encrypted document. The requested document is decrypted and sent to the requesting client.

Another method for serving Internet-based documents to at least one client is provided. A client-accessible document is received. A determination is made as to whether or not the document is to be a secured document. If so, the document is encrypted. The document is stored. A request is received from at least one client to access the document. If the document is a secure document, the document is decrypted. The document is then sent to the requesting client.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a block diagram illustrating an Internet-based document system according to an embodiment of the present invention;

FIG. 2 is a flow diagram illustrating document storage according to an embodiment of the present invention; and

FIG. 3 is a flow diagram illustrating document retrieval in response to a client request according to an embodiment of the present invention.

### DETAILED DESCRIPTION OF THE PREFERRED EMBODIMENT(S)

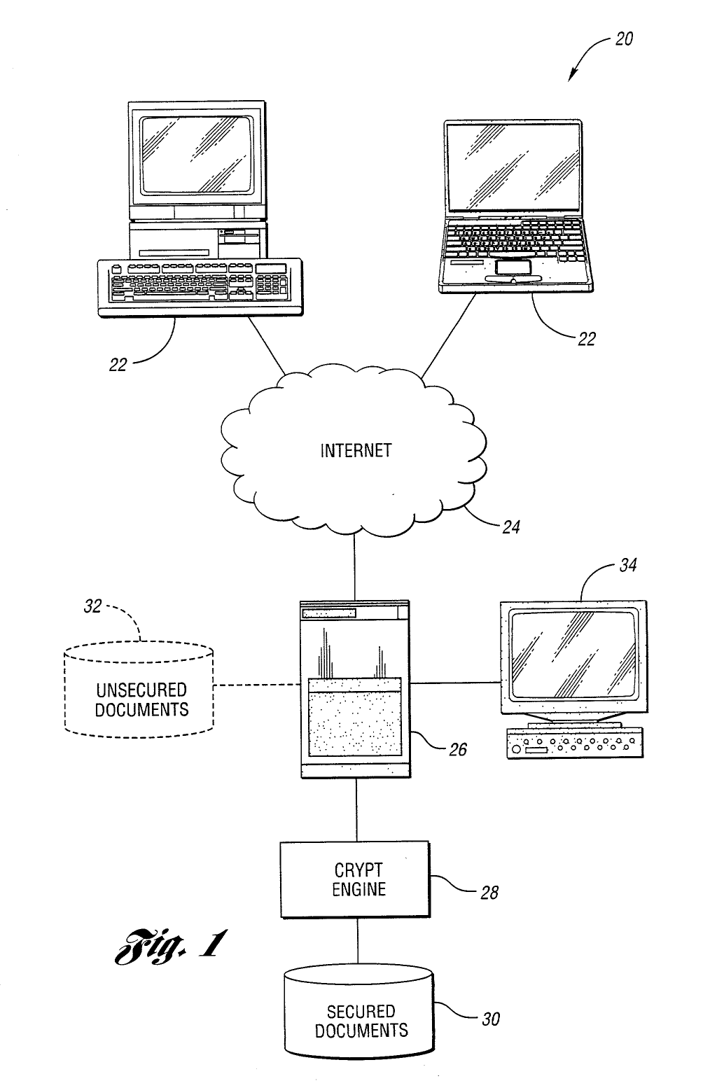

Referring to FIG. 1, a block diagram illustrating an Internet-based document system according to an embodiment of the present invention is shown. A document system, shown generally by 20, provides documents to one or more clients 22 through the Internet 24. These documents preferably include web pages written in a hypertext markup language such as, for example, HTML. Documents may also include other forms of information such as text, audio, video, and the like. Documents are provided to clients 22 through server 26. Typically, a secure connection such as Secure Sockets Layer (SSL) is established between server 26 and client 22 requesting a document. This permits the document to be securely transferred over the Internet.

Documents held by server 26 are typically stored in a readable fashion. Internet server 26 may include a firewall or other software means to prevent unauthorized access of stored documents. However, once such security is breached, an intruder has access to all documents held by server 26. Thus, previous to the present invention, websites have been vandalized by altering stored documents.

To prevent the unauthorized access of documents, system 20 includes crypt engine 28 and secure storage 30. Crypt engine 28 encrypts each document prior to storing in secure storage 30 and decrypts the document when retrieved from secure storage 30 for delivery to each requesting client 22. Such documents held within secure storage 30 are referred to as secured documents.

Crypt engine 28 can encrypt or decrypt a stream of bytes using a particular encryption algorithm. This algorithm may be as complex as deemed necessary for a particular application or Internet site. The algorithm is preferably a pluggable component of crypt engine 28. Crypt engine 28 may be implemented in hardware, software or a combination of hardware and software. Crypt engine 28 may be implemented as part of server 26 or as a separate device. Preferably, crypt engine 28 is implemented in software on a processor separate from server 26. The construction of code to implement crypt engine 28 is well known in the art of computer science.

Crypt engine 28 may also handle authentication and authorization of encrypting and decrypting. Preferably, the only process allowed to access crypt engine 28 is server 26. This prevents an unauthorized accessor of server 26 from using crypt engine 28 to decrypt a secured document held in secure storage 30. Preferably, server 26 never permanently stores a document intended as a secured document outside of secure storage 30.

Document system 20 may also include unsecure storage 32 accessible by server 26. Unsecure storage 32 may hold unsecured documents for delivery to clients 22. Such documents may include material uploaded by clients 22 for access by other clients 22, information deemed not important enough to warrant encryption, and the like. Secure storage 30 and unsecure storage 32 may be implemented using the same device, such as a magnetic hard disk. Preferably, secure storage 30 and unsecure storage 32 are implemented as separate storage devices.

System administrator 34 uploads unencrypted documents for access by clients 22. System administrator 34 may also provide an indication as to whether or not uploaded documents are to be secured. System administrator 34 may upload documents to be secured directly to crypt engine 28 or, preferably, system administrator 34 may upload documents to server 26.

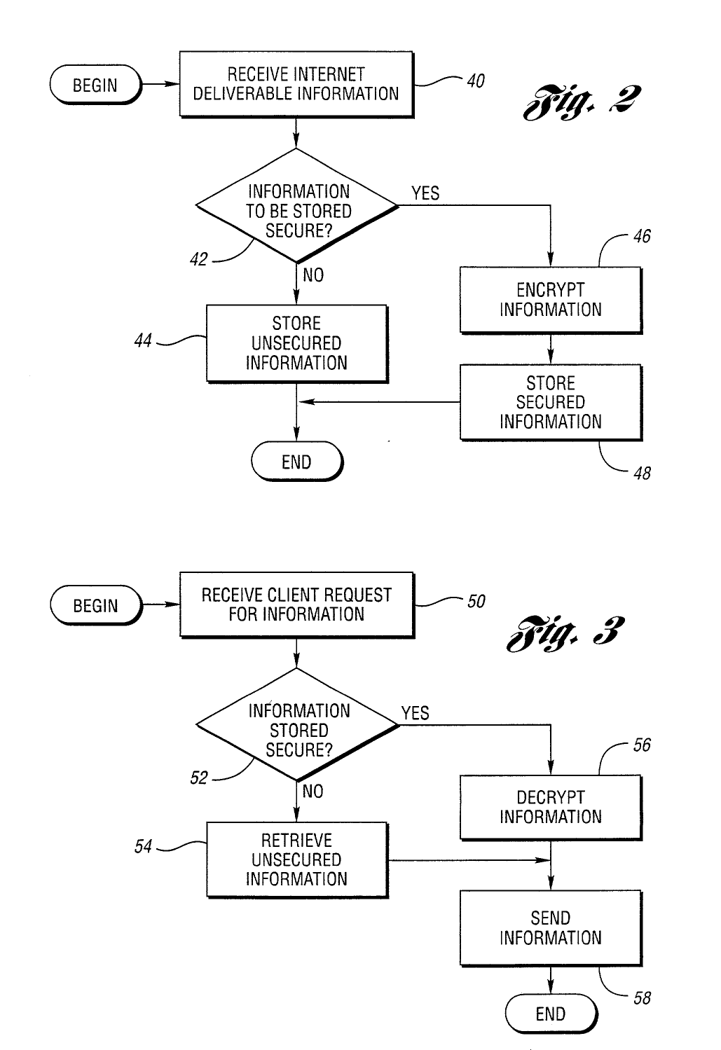

Referring now to FIG. 2, a flow diagram illustrating document storage according to an embodiment of the present invention is shown. Internet deliverable information is received, as in block 40. For example, system administrator 34 uploads documents that may be requested by clients 22 to server 26. A check is made to determine if the information to be stored is secure, as in block 42. In one embodiment of the present invention, system administrator 34 indicates for each document whether the document is to be secured or unsecured. In another embodiment of the present invention, all documents are treated as secured. In yet another embodiment of the present invention, system administrator 34 designates classes of documents as either secured or unsecured. Server 26 then proceeds based on the class of the document received.

If the information received is not secured, the information is stored as in block 44. Server 26 stores unsecured information in unsecure storage 32.

If the received information is to be secured, the information is encrypted as in block 46. Crypt engine 28 encrypts the received information. Preferably, crypt engine 28 first checks the encryption request for authentication or authorization. For example, crypt engine 28 may only encrypt information from an authorized system administrator 34. The secured information is stored, as in block 48. Once encrypted, the information is stored as a secured document in secure storage 30.

Referring now to FIG. 3, a flow diagram illustrating document retrieval in response to a client request according to an embodiment of the present invention is shown. A client request for information is received, as in block 50. Client 22 forwards a request for a document to server 26. Server 26 may perform authorization or authentication of client 22 if the requested document is not a public document, as is known in the art.

A check is made to determine if the stored information is secured, as in block 52. Server 26 determines if the requested document is secured. Server 26 may maintain a table of all stored documents which includes an indication of the secured status of each document. Alternatively, server 26 may search secure storage 30 and unsecure storage 32 to find the location of a requested document. If the document is not secured, the unsecured information is retrieved as in block 54.

If the requested information is secured, the information is decrypted as in block 56. Crypt engine 28 retrieves the secured document from secured storage 30, decrypts the document and forwards the decrypted information to server 26.

The information is sent, as in block 58. Whether the information resided as a secured document in secure storage 30 or an unsecured document in unsecure storage 32, server 26 eventually retrieves an unencrypted version of the requested document. Server 26 then sends the requested information to requesting client 22.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for serving documents over the Internet to a plurality of clients comprising:
a server in communication with the Internet, the server sending documents over the Internet in response to a request from at least one of the clients;
a secure storage holding encrypted documents; and
a crypt engine in communication with the server and the secure storage, the crypt engine encrypting each document when stored in the secure storage and decrypting the document when retrieved from the secure storage for delivery to each requesting client.

2. A system for serving documents as in claim 1 wherein the server never permanently stores, as an unencrypted document outside of the secure storage, a document held in the secure storage.

3. A system for serving documents as in claim 1 further comprising a system administrator in communication with the server, the system administrator operative to upload unencrypted documents to the server for access by the clients, the unencrypted documents encrypted by the crypt engine and stored in the secure storage.

4. A system for serving documents as in claim 1 further comprising an unsecure storage holding unencrypted documents.

5. A system for serving documents as in claim 4 wherein the server is further operative to:
receive the client request for access to a document;
determine whether or not the requested document is in secure storage or unsecure storage;
if the document is in unsecure storage, retrieve the document from unsecure storage and send the document to the requesting client;
if the document is in secure storage, decrypt the document through the crypt engine and send the document to the requesting client.

6. A method for serving Internet-based documents to at least one of a plurality of requesting clients, the method comprising:
encrypting and storing a document;
receiving a request from one of the clients to access the encrypted document;
decrypting the requested document; and
sending the unencrypted requested document to the requesting client.

7. A method for serving Internet-based documents as in claim 6 wherein documents to be encrypted and stored are first received by an Internet server receiving the client request.

8. A method for serving Internet-based documents as in claim 6 further comprising:
receiving the document;
specifying whether or not the received document will be encrypted;
storing the document without encryption if the document is not specified to be encrypted; and
only encrypting and storing the document if the document is specified to be encrypted.

9. A method for serving Internet-based documents as in claim 6 wherein encrypting and storing the document is through a crypt engine in communication with an Internet server, the Internet server receiving the client requests.

10. A method for serving Internet-based documents to at least one of a plurality of requesting clients, the method comprising
receiving a client-accessible document;
determining if the document is to be a secured document and, if so, encrypting the document;
storing the document;
receiving a request from at least one client to access the document;
if the document is a secured document, decrypting the document; and
sending the document to the requesting client.

11. A method for serving Internet-based documents as in claim 10 wherein storing the document is performed by a crypt engine that encrypts the document if the document is determined to be a secured document.

12. A method for serving Internet-based documents as in claim 10 wherein the document and the access request are received by a server in communication with clients through the Internet.

13. A method for serving Internet-based documents as in claim 10 wherein client-accessible documents are received from a system administrator also providing the determination of whether or not the document is to be a secured document.
